(19) United States
(12) Patent Application Publication
(10) Pub. No.: US 2025/0219112 A1
(43) Pub. Date: Jul. 3, 2025

(54) MANIFOLD AND METHODS FOR DISTRIBUTING SLURRY-BASED ELECTRODES IN FLOW BATTERY CELLS

(71) Applicant: CASE WESTERN RESERVE UNIVERSITY, Cleveland, OH (US)

(72) Inventors: Nicolas SINCLAIR, Cleveland, OH (US); Jesse WAINRIGHT, Cleveland, OH (US); Robert SAVINELL, Cleveland, OH (US)

(21) Appl. No.: 19/001,765

(22) Filed: Dec. 26, 2024

Related U.S. Application Data
(63) Continuation of application No. PCT/US2023/020192, filed on Apr. 27, 2023.
(60) Provisional application No. 63/355,735, filed on Jun. 27, 2022.

(51) Int. Cl. H01M 8/04082; H01M 8/18

(52) U.S. Cl. CPC H01M 8/04201; H01M 8/188

(57) ABSTRACT

A flow battery relies on slurry-type electrode in which particles may be selectively and temporarily plated (relative to a solid/standard electrode). Owing to the comparatively viscous nature of the slurry, specific accommodations for the electrolyte flowpaths must be made, thereby eliminating problematic reaction areas across certain facings of the solid electrode that might otherwise impede slurry flow and/or degrade performance of the battery. Methods of operating such a battery, storing electrical energy, and other related processes are also contemplated.

### CROSS REFERENCE TO RELATED APPLICATIONS

This invention was made with government support under Contract DE-AR0000352 awarded by the United States Department of Energy (ARPA-E), and this application claims priority to and incorporates by reference U.S. provisional patent application Ser. No. 63/355,735 filed on Jun. 27, 2022. The government has certain rights in the invention.

### TECHNICAL FIELD

The present invention relates generally to the field of flow batteries and, more specifically, to an all iron, slurry-based flow battery including systems and methods for distributing slurry-based fluids as needed within the structures of such batteries.

### BACKGROUND

A flow battery is a rechargeable battery that uses electrolytes moving (“flowing”) through an electrochemical cell to convert chemical energy from the electrolyte into electricity (and vice versa when charging). The active materials used in flow batteries are generally composed of ionized metal salts or redox active organic compounds dissolved in a fluid, such as water or an organic solvent(s). Additional salts or acids, such as NaCl or HCl, may also be provided to the fluid so as to create a highly conductive electrolyte.

One iteration of such batteries focuses on using mild pH, non-toxic electrolytes consisting of iron-based slurries at varying oxidation states. The reactions proceed under charge as follows:

$$Positive : 2 {Fe}^{2 +} \to 2 {Fe}^{3 +} + 2 {e}^{-} ( {E}^{0} = + 0 \text{.77} V vs NHE ) \\ Negative : {Fe}^{2 +} + 2 {e}^{-} \to {Fe}^{0} ( {E}^{0} = - 0 \text{.44} V vs NHE )$$

Slurries for the electrodes are made by mixing conductive particles in the electrolyte. Iron is plated onto the particles during charging, so that the particles may be circulated through the cell and/or removed for external storage. Owing to the ubiquitous presence of iron, flow batteries having this design present numerous advantages in comparison to conventional lithium-ion and other battery types requiring rare earth and/or more expensive or difficult to work metals (e.g., nickel, silver, lithium, etc.).

Generally speaking, each cell in a flow battery consists of a positive (cathode) and negative (anode) electrode and a separating membrane. The electrodes catalyze the desired reactions. The membrane allows the conduction of ions necessary to complete the electrical circuit, while preventing the electrodes from coming into contact. The separator should also prevent any mixing of the circulating positive and negative electrolytes and minimize the movement of species produced in an electrolyte during charging from crossing over or intermingling with the other components (e.g., the other electrolyte). Additional mechanical and control structures may be employed to generate and sustain the desired flow of electrolyte/reactants through the cell(s).

A true flow battery has all the active chemical species flowing through the battery and stored in the external tanks. Reduction-oxidation (redox) flow batteries, such as vanadium or iron redox batteries, store electrical energy in a chemical form and subsequently dispense the stored energy in an electrical form via a spontaneous reverse redox reaction. The discharged electrolyte can be flowed through a reactor cell with an external voltage source applied such that electrical energy is converted back to chemical energy.

In practice, flow batteries are similar to fuel cells, in that they rely upon electron transfer (rather than intercalation or diffusion). Flow batteries also possess similarities to rechargeable batteries, in that the active material may be easily replenished outside of the cell (e.g., in the storage tanks through the application of an appropriate electrical charge).

Taken together, flow batteries have advantages in comparison to the conventional batteries. In particular, conventional batteries have limited discharge capacity based upon the active material contained within the cell (a parallel can also be drawn to rechargeable batteries in this regard, in that rechargeable batteries have limitations on cycling owing to the inherent limitations of repeated intercalation).

To date, flow batteries have found utility in larger, stationary applications and/or in combination with other power generation schemes. Nevertheless, flow batteries may soon find new use/application in “traditional” energy industry concerns, including hydrocarbon producers and alternative energy concerns because of their potential portability and reusability. In particular, portable power device manufacturers and hybrid/electric vehicle maker may soon consider flow battery systems to overcome the shortcomings noted above.

Examples of flow batteries can be found in U.S. Pat. No. 9,569,375; International Patent Application No. PCT/US16/56230 filed on Oct. 10, 2016; and International Patent Application No. US15/50676 filed on Sep. 17, 2015. These disclosures are be incorporated by reference herein, particularly to the extent certain aspects inform the background and state of the art.

An alkaline zinc-ferricyanide (Zn—FeCN) battery is described in U.S. Pat. No. 4,180,623, but high membrane costs and the complexity of handling zinc oxide solid precipitates continue to prevent widespread adoption of this technology. Further iterations have focused on using the ferrocyanide-ferricyanide (FeCN) complex as the positive redox couple which relies entirely on fully complexing (i.e., the reactants must form complexed metal ions), although these iterations suffer from the fact that the FeCN couple has a potential about 400 mV less-positive than Fe (II/III), as well as issues relating to low solubility and the production of toxic gas if the complex is mixed with acid.

Zinc-based hybrid flow batteries rely on zinc's desirably low potential (E⁰=−0.76 VSHE) and high overpotential for hydrogen evolution reactions. Thus, zinc-bromine batteries have been developed, but the use of bromine also requires complexing agents. Additionally, the inherent toxicity of bromine itself presents challenges. Cerium, vanadium, and nickel have also been considered, but these metals tend to add expense and create still further technical challenges.

A zinc-iron flow battery requiring deep eutectic solvents (DES) with an open-circuit potential of 1.02 V was reported in more recent academic literature, but it required excessive temperatures well above ambient conditions in order to provide useful power densities. Additional iron-based flow batteries using triple electrolyte systems and/or selective ion exchange membranes have also been investigated, although the former requires considerable complexity and the latter involves an acidic electrolyte (e.g., zinc sulfate), buffering agents, and other potentially complicated and/or expensive components-particularly in comparison to widely available microporous polymeric membranes. Further, this acidic sulfate system experienced capacity fade, thereby implying difficulty in operating a battery with mixed zinc-iron electrolytes because the ferrous or ferric ions present in the negative electrolyte would be reduced in place of the zinc ions, as noted by Xie in “High performance of zinc-ferrum redox flow battery with Ac/HAc buffer solution,” Journal of Energy Chemistry, Vol. 25, Issue 3, pp. 495-499, May 2016.

### SUMMARY

The present system leverages the advantages of flow batteries and realizes improvements over the aforementioned systems by using a slurry of iron to contain the plating reactions in an all-iron battery.

In various aspects, a specially designed manifold delivers slurry across a gap defined by a current collector plate and cell membrane. The manifold is connected to the slurry reservoir and redirects it, via a transition section that avoids eddy currents and a ramped section configured to manage pressure drop and avoid accumulation of reactants that might otherwise block flow, across the current collector plate. A similar set of connections is provided on the opposite side of the current collector, thereby forming de facto inlets and outlets. The current collector plate may have a prismatic shape, and a stack or series of plates and membranes may be configured into the manifold design to allow for greater versatility in adjusting the overall performance characteristics of the battery.

Other aspects include a method of delivering slurry to an electrode stack, largely relying on the structure and/or configuration of the manifold noted above. Other methods could include steps for operating a slurry battery without creating obstructions to reactant flow. Still other methods may be apparent to persons of ordinary skill contemplating this disclosure.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the invention as if fully rewritten herein.

In the drawings:

FIGS. 1A and 1B are, respectively speaking, a schematic representations of a flow battery apparatus and slurry reaction mechanisms appropriate for certain disclosed aspects of the invention.

FIG. 2 provides information on the slurry viscosity normalized to the base electrolyte to highlight shear thinning behavior.

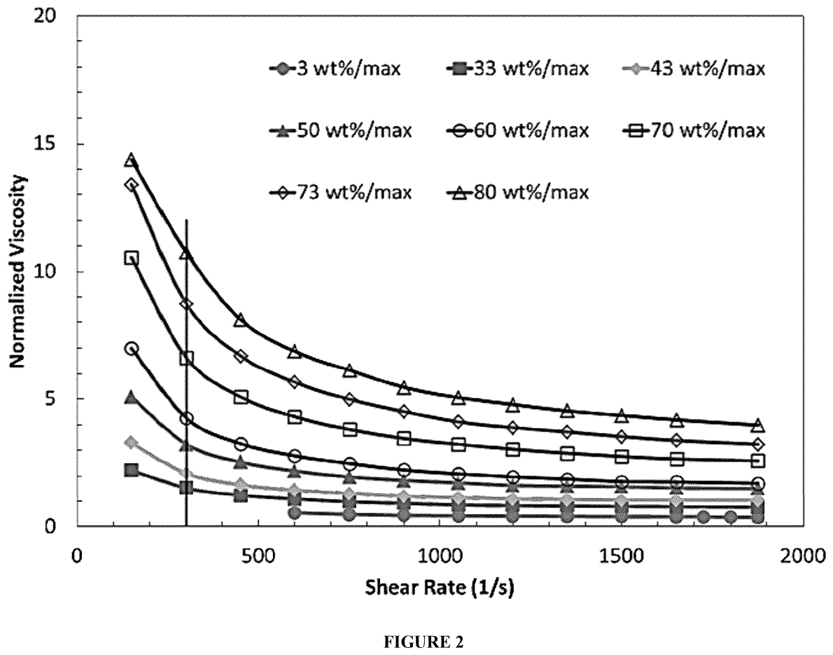

FIG. 3 illustrates exemplary cell voltage while cycling according to certain disclosed aspects of the invention.

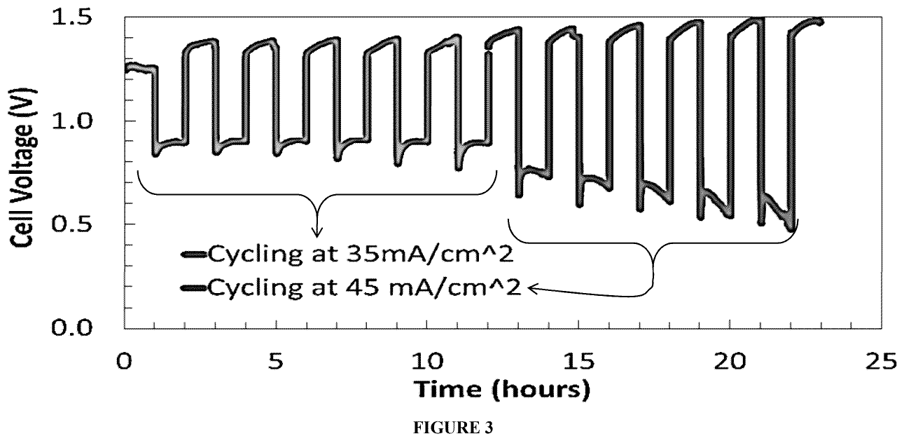

FIGS. 4A and 4B are exemplary configurations for the fluidic connections to realize the benefits associated with certain disclosed aspects of the invention, with FIG. 4B providing an exploded view of callout 4 in FIG. 4A.

FIG. 5 is a top plan view the electrode-slurry interface (along its according to certain disclosed aspects of the invention.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise. Terms of art should be afforded their customary meaning within the context that they are used.

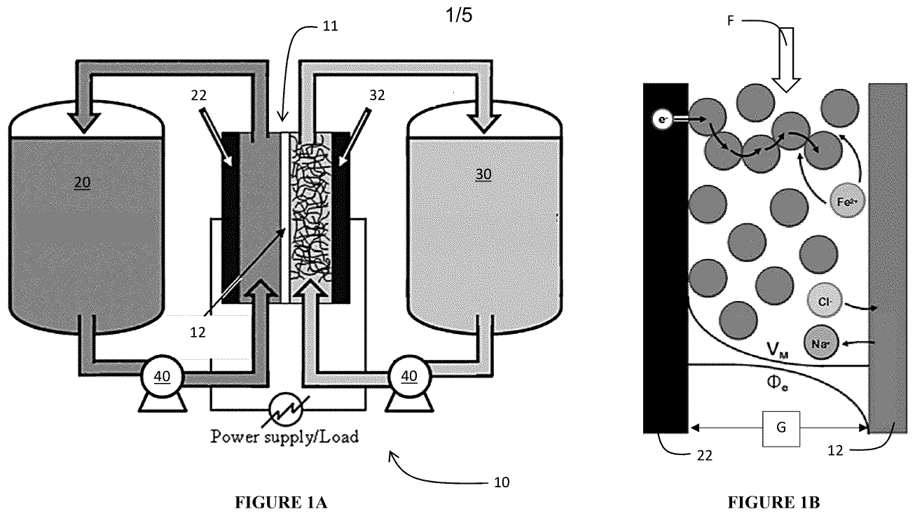

The cell design described below allows for the implementation of a slurry electrode in a flow battery containing a plating reaction. With reference to FIGS. 1A and 1B, flow battery 10 relies on iron-based slurry electrodes 20, 30. The slurry is fed, via pumps 40, into a reaction cell 11. The cell includes positive and negative current collector plates 22, 32, along with a porous membrane 12. The cell 11 is connected to a power supply or load, which may have appropriate controls, to facilitate charging and discharging of the battery 10. The flow F of slurry passes between gap G between either of the current collectors 22, 23 and the separator 12, with the various ionic species present as indicated in the schematic representation in FIG. 1B.

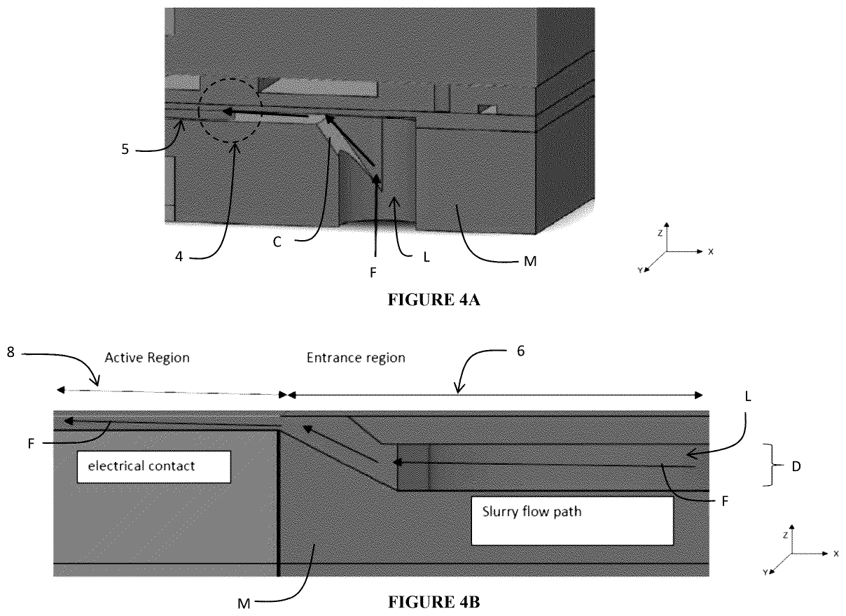

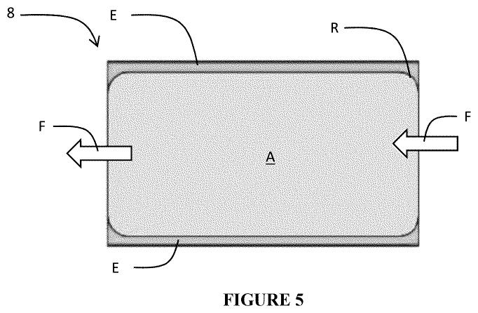

The slurry electrode consists of conductive particles suspended in an electrolyte solution. In order for electrons to flow into and taken out of the slurry electrode, a structure was designed that would allow for electrical contact to the slurry. In addition, the structure evenly distributes the slurry electrode flow across the surface of the electrical contact. The design also incorporates smooth flow transitions to avoid having the solid particles collect at constrictions in the flow. This is critical as regions where the particles collect will eventually lead to failure due to clogging of the flow. These flow transitions are enabled through the use of the manifold and related structures described and disclosed in connection with FIGS. 4A, 4B, and 5 below.

Because conventional flow battery hardware designs contain many such constrictions in order to distribute flow and control shunt losses, conventional flow batter design are often unsuitable for use with a slurry electrode. Additionally, the cell gap between membrane and electrical contact must be defined to minimize electrical resistance through the slurry electrode but also to avoid excessive pressure drop impeding flow.

The inventors have now discovered an optimal gap G to be in the range of 100-1000 μm allows for the use of slurry electrodes, and particularly slurries designed for iron flow batteries. Notably, larger gaps would be suitable for more conductive slurries. Further, the inventors determined electrical contact area A must contain an inert space along the edges E parallel to the flow F of the slurry electrode. This spacing prevents the accumulation of plated particles due to the low linear velocity associated with the no-slip condition along the edges of the cell area. While the parallel edges E confined slurry flow F, the upstream and downstream edges will be open. In some aspects the edges E include radiused or curved ends at one or both of the upstream and downstream edges to facilitate and enable the desired flow patterns described herein.

With reference to FIG. 4A, slurry must also be gently transitioned when changing direction in order to prevent areas of low flow or eddies from forming which can lead to particle settling. Here in a cut-away view of a stack design, flow enters in a manifold M in the Z-dimension, and must make a 90° turn to flow across the active area of the cell as indicated by the arrows F This flow pattern is dictated by exemplary lumen L. While a single lumen L is illustrated, it will be understood a single metallic, polymeric, or other formed, cast, or molded object may define multiple lumens in which each lumen feeds a discrete active region 8. Each lumen also possesses a diameter D that gradually reduces along each transition point (The inside corner C on that lumen is angled to avoid an eddy at the corner. A similar feature/manifold M is positioned on the outlet side of the active area 8 (with the flow arrows F simply being reversed).

As can be seen in the cross-section view shown in FIG. 4B the thickness of the flow path is smoothly reduced in the entrance region 6 before entering the active region 8 (also depicted in isolated top view in FIG. 5). In the active region, the gap between the electrical contact and the membrane dividing the cell is 600 μm. To the far right, where slurry enters, the flow path is ca. 2 mm wide in the Z direction. The ramped reduction in the flow path in the Z direction causes a controlling pressure drop that spreads and distributes the flow evenly in the XY plane without placing obstructions in the flow path of the slurry. Such obstructions would cause a dead zone where particles can settle, leading to clogging and failure. Simulations of the flow show the velocity is across the active area is uniform (within +2%). The ramped feature is used on both the inlet and outlet ends of the active area.

Based upon flow simulations, there is an area of low flow velocity predicted along the edges of the active area despite the use of the ramped header design to control flow distribution because of unavoidable, no-slip conditions at the edges of the cell area lateral running along both sides between the inlet and outlet areas. Due to the nature of the plating reaction that the slurry electrode is intended for, these areas of low flow along the edges receive more plating per pass than the particles in the area of higher flow. This can lead to particles becoming fused together and becoming fixed within the cell which will eventually lead to cell failure. To avoid this outcome, the flow field has been designed with inert, non-conductive areas along the cell edges E as shown in darkened edge portions at the top and bottom sections in FIG. 5 (with flow expected to move right to left or vice versa). These areas correspond to the areas of low velocity as determined by the computational fluid dynamics simulation. These areas receive no current and thus no plating reaction occurs in this region, and a build-up of particles in the cell is avoided.

Simulations demonstrate the effectiveness of the ramped header design, so that (with the exception of the edge regions the velocity across) the active area should be 0.051±0.001 m/s, which is a mere 2% variation. The ramped design also provides sufficient flow restriction so that the flow velocity across the active area should be uniform to within ±10% (0.08±0.008 m/s). These simulations were based upon a stackable 1156 cm² cell.

The disclosed manifold and methods for distributing slurry are particularly useful in individual reaction chambers or cell (in which collector plates “sandwich” the separator membrane). As is known in this field, a series or “stack” of such reaction chambers can—and often are—required to construct a useful battery, with those stacked chambers aligned and standardized to realize the most efficient use of space. Therefore, it is envisioned the structures and principles for operation in a single cell can be multiplied and applied to an entire cell stack. Similarly, while the emphasis was on delivery of slurry into the cell, corresponding methods apply mutatis mutandis for removing slurry out of the cell.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A flow battery comprising:
positive and negative current collector plates, each configured to contact a slurry flowing between an inlet and an outlet and laterally across a gap formed by facings of the positive or negative current collector plate and a separator;
positive and negative electrolyte reservoirs wherein at least of the positive and negative electrolyte reservoirs is configured to contain a slurry in which selectively plated reaction particles are carried in an electrolyte fluid;
a manifold assembly defining a flow passage transporting the slurry to the gap, the passage including a transition corner section connecting at opposite ends between an approach tube and a feeder section, wherein the approach tube and transition corner section redirect flowing slurry along a 45° angle (+/−5°) and the transition corner and feeder redirect flowing slurry along another 45° angle (+/−) 5° so that slurry is orthogonally redirected by the manifold assembly; and
a ramped flow distributor disposed between the inlet and the feeder, said ramped flow distributor having an entrance region and a flow region, wherein a diameter of slurry flow path in the entrance region is larger than a diameter in the flow region and wherein a ramp redirects slurry flow as the diameter of the entrance region transitions to the diameter of the flow region; and
wherein at least one of the manifold assembly and the ramped flow distributor overlay the current collector plate in the flow region so as to prevent slurry from coming into conductive contact with lateral edges of the gap.

2. A flow battery having at least one slurry electrode, the battery having a positive electrode structure, a negative electrode structure, and a separator disposed between the positive and negative electrode structures and further comprising:
(a) an evenly distributed slurry electrode flow;
(b) a smooth flow transition;
(c) an electrical contact area having predetermined inert space along selected edges thereof; and
(d) a cell gap.

3. The battery according to claim 2 further comprising a manifold for evenly distributed and smooth transition slurry electrode flow.

4. The battery according to claim 3 wherein the manifold comprises a pressure drop structure.

5. The battery according to claim 4 wherein the pressure drop structure includes a ramped feeder section in which a lumen for slurry electrode flow reduces in diameter while angularly redirecting the slurry electrode.

6. The battery according to claim 5 wherein ramped feeder section is immediately upstream from an active region in which the slurry electrode makes electrical contact with active portions of the flow battery.

7. The battery according to claim 2 wherein the predetermined inert space is symmetrically formed about an axis of flow the slurry electrode.

8. The battery according to claim 7 the predetermined inert space is positioned at peripheral edges of an active region of a reaction chamber in the positive and/or negative electrode structures.

9. The battery according to claim 8 wherein the peripheral edges define a quadrilateral shape having curved sections overlaid at each corner.

10. The battery according to claim 2 wherein the cell gap is defined by a distance between membrane and electrical contact, as measured orthogonally to an axis of flow of the slurry electrode, and configured to minimize electrical resistance in the slurry electrode and/or configured to avoid excessive pressure drop that would impede flow of the slurry electrode.

11. The battery according to claim 10 wherein the distance is between 100 and 1000 micrometers and selected based upon a conductivity of the slurry electrode.

12. The battery according to claim 3 wherein the manifold is configured for use in an all-iron flow battery having one or more reaction chambers defined by an electrode plate set apart by a gap from a membrane so that slurry fills and flows through the gap, the manifold:
a ramped feeder section coupled to an inlet of a reaction chamber and disposed at a first redirection angle, wherein the ramped feeder section is configured to control pressure drop while spreading and distributing slurry flow evenly across a facing of the current collector and/or membrane except for inert and non-conductive laterally opposing edges wherein each edge has symmetric, curved corners connected to the inlet and the outlet;
a transition section coupled to the ramped feeder section; and
an approach tube coupled the transition section and disposed at a complimentary angle relative to the angle relative to the first angle, wherein the approach tube also coupled to a slurry reservoir to the one ore more reaction chambers.

13. The battery according to claim 3 wherein the manifold comprises:
one or more approach tubes connected to a slurry reservoir and oriented to provide slurry at an orthogonal angle relative to a facing of the current collector and/or the separator membrane;
one or more transition sections, each positioned between one approach tube and an inlet to the cell gap, the transition section configured with an inside corner angled and configured to avoid eddy currents in slurry flowing therethrough; and
an electrode flow chamber connected to the transition section, the flow chamber restricting slurry electrode flow along peripheral edges of the facing and further defining the inlet, which is positioned opposite an outlet from the cell gap, the electrode flow chamber having symmetrical, curved and elongated sections on the peripheral edges between each of the inlet and the outlet so as to create inert, non-conductive regions thereon.

14. A method for operating a flow battery having a slurry electrode in which particles may be selectively plated when the particles are passed through a reaction chamber, the method comprising:
providing a slurry electrode and a reaction chamber;
directing the slurry electrode from a reservoir through a transition section having two spaced apart, angled sections configured to avoid eddy currents;
constricting flow the slurry electrode immediately before providing the slurry electrode to an inlet of the reaction chamber, said constricting eliminating pressure drop;
creating inert, non-conductive areas at lateral edges of the reaction chamber in which no-slip conditions occur; and
removing the slurry electrode through an outlet and transporting the slurry electrode a second transition section having two spaced apart, angled sections configured to avoid eddy currents and back to the reservoir.
